(19) United States
(12) Patent Application Publication
(10) Pub. No.: US 2017/0010896 A1
(43) Pub. Date: Jan. 12, 2017

(54) Shared Memory Architecture Autoupdater

(71) Applicant: LEAR CORPORATION, Southfield, MI (US)

(72) Inventors: David Gamez ALARI, Valls (ES); Jordi Moreno AYMAMI, Valls (ES); Antoni Ferré FÀBREGAS, Valls (ES); Jignesh CHAUHAN, Pune (IN); Rahul RANADE, Pune (IN)

(21) Appl. No.: 14/791,612

(22) Filed: Jul. 6, 2015

(51) Int. Cl. G06F 9/44

(52) U.S. Cl. CPC G06F 9/4401

(57) ABSTRACT

A method of updating a bootloader includes a slave controller that includes a central processing unit in communication with non-volatile memory having a shared memory architecture. The shared memory architecture including a non-volatile application memory block having application code and a non-volatile launcher memory block having bootloader code for initiating the slave controller. The method including a step of storing updated code to an application memory block of the non-volatile memory. The updated code includes a first code section having application code for application functions, a second code section having updated bootupdater code, and a third code section having image code for an updated bootloader. Slave controller receives indication to update the bootloader code stored in the non-volatile launcher memory block and then executes the bootupdater stored in the application memory block to update the bootloader stored in the launcher memory block from the image code for an updated bootloader.

### CROSS-REFERENCE TO RELATED APPLICATIONS

This application relates to commonly owned U.S. application Ser. No. 12/796,774, entitled Method and System of Updating Shared Memory Architecture, filed Jun. 9, 2010, and U.S. application Ser. No. 13/921452 entitled Shared Memory Architecture, filed Jun. 19, 201; the disclosures of which are incorporated in their entireties by reference herein.

### TECHNICAL FIELD

The present invention relates to a shared memory architecture where code or other data sufficient to support shared functionality is stored to a shared memory block.

### BACKGROUND

Software code, such as the type used to support functions performed by a central processing unit (CPU), is typically written to perform specific operations. The code associated with one piece of software may not be usable with code written for another piece of software. When a memory is tasked with storing code for multiple pieces of software, the code for each piece of software must be fully stored to the memory. In the event two or more pieces of the software facilitate execution of the same or similar functions, memory space is allocated to store the corresponding code for each of the two or more pieces of software. This creates redundancy insofar as duplicate code is stored for the same or similar functions.

The prior art provides various solutions for reducing the amount of duplicate code. For example, U.S. application Ser. No. 12/796,774 and U.S. application Ser. No. 13/921452 provide solutions to the occurrence of duplicate code by providing a shared memory architecture. Although some of the prior art solutions work well, there remains a need for efficient methods for updating bootloaders in electronic control units using shared memory architectures.

### SUMMARY

The present invention solves one or more problems of the prior art by providing, in at least one embodiment, a method of updating a bootloader which includes a slave controller. The slave controller includes a central processing unit in communication with non-volatile memory having a shared memory architecture. The shared memory architecture includes a non-volatile application memory block having application code and a non-volatile launcher memory block having bootloader code for initiating the slave controller. The method includes a step of storing updated code to an application memory block of the non-volatile memory. The updated code includes a first code section having application code for application functions, a second code section having updated bootupdater code, and a third code section having image code for an updated bootloader. Slave controller receives an indication to update the bootloader code stored in the non-volatile launcher memory block and then executes the bootupdater stored in the application memory block to update the bootloader stored in the launcher memory block from the image code for an updated bootloader,

In another embodiment, a control system having a shared memory architecture is provided. The control system includes a master controller and a slave controller. The master controller has a first central processing unit and a first memory. The slave controller has a second central processing unit and a second memory. The slave controller is in communication with the master controller. Characteristically, the second memory includes non-volatile memory having a launcher memory block having bootloader code encoded therein, a shared memory block having shared code encoded thereon, and an application memory block. The application memory block includes a first code section having application code for application functions, a second code section having updated bootupdater code, and a third code section having image code for an updated bootloader. The second central processing unit is configured to receive an indication to update the bootloader code stored in the launcher memory block and execute the bootupdater code stored in the application memory block to update to bootloader stored in the launcher memory block from the image code for an updated bootloader.

### BRIEF DESCRIPTION OF THE DRAWINGS

FIG. 1 provides a schematic illustration of a control system implementing a bootloader updating procedure;

FIG. 2 is a schematic flowchart illustrating a method of updating a bootloader in an electronic control unit;

FIG. 3 provides a schematic illustration of a controller system having a shared memory architecture suitable for battery management system application; and

FIG. 4 provides a schematic illustration of a controller system having a shared memory architecture suitable for a body central module.

### DETAILED DESCRIPTION

Reference will now be made in detail to presently preferred compositions, embodiments and methods of the present invention which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

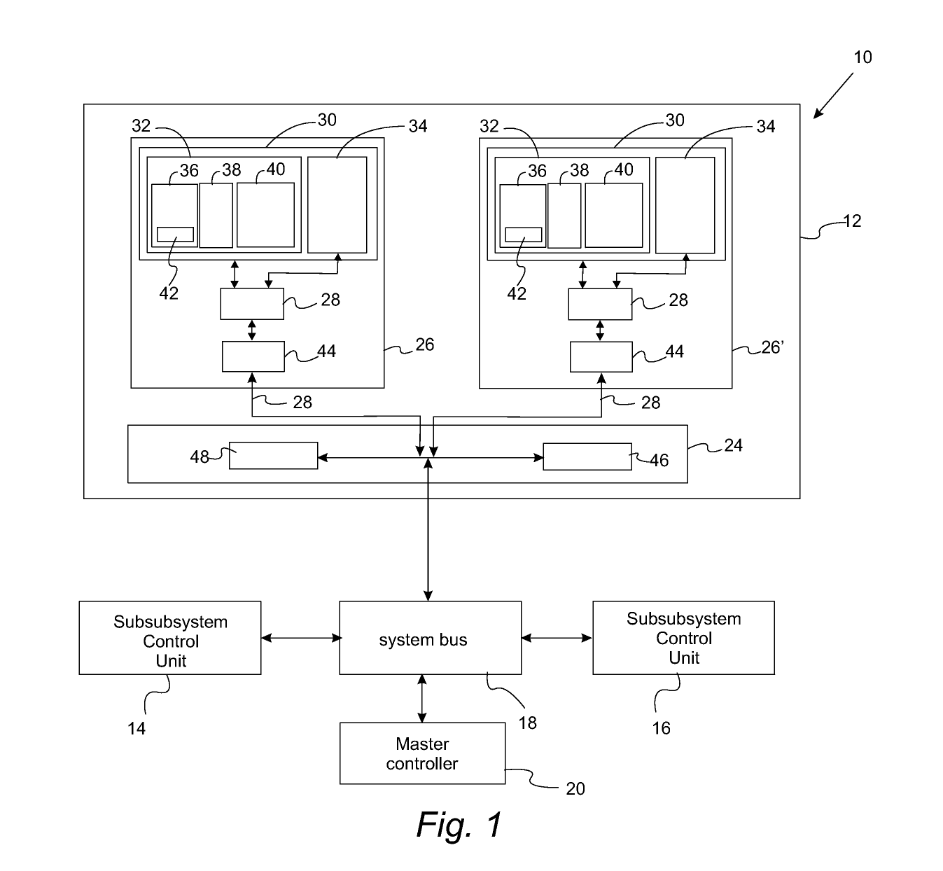

With reference to FIG. 1, a schematic illustration of a controller system using a shared memory architecture is provided. Controller system 10 includes subsystem control unit 12 and one or more optional subsystem control units 14, 16. It should be appreciated that controller system 10 can include virtually any number of subsystem control units. Subsystem control units 12, 14, 16 are electronic control units (ECU). In a variation, the operation, update, interaction, and control of the subsystem control units can be directed with communications carried over a system bus 18 according to instructions issued by master controller 20 which can be a system master controller or a diagnostic tester. In a refinement, controller system 10 is a vehicle control system. Such a vehicle control system is included within a vehicle (not shown) and has a number of vehicle subsystems (not shown) controlled by one or more vehicle subsystem controllers 12, 14, 16. Examples of such control systems include, but are not limited to, vehicle infortainment, security (passive entry, remote keyless entry, etc.), illumination, heating and air conditioning, and engine control subsystems.

Control unit 12 describes in detail the implementation of a shared memory architecture, and in particular, the process for updating a bootloader. Detailed descriptions of shared memory architectures that can be used in the present invention are set forth in U.S. Published Applications 2011/0307669 and 2011/0307667; the entire disclosures of these applications are hereby incorporated by reference. It should be appreciated that one or more of the optional control units can also implement such a shared memory architecture.

Subsystem controller 12 includes master controller 24 in communication with one or more slave controllers 26, 26′ over subsystem bus 28. Each of master controller 24 and slave controller 26 include a central processing unit (CPU) and computer memory. In a refinement, the slave controllers and the master controller are each independently microcontrollers that include a microprocessor. In particular, slave controllers 26, 26′ include CPU 28 which is in communication with memory 30. Memory 30 includes non-volatile memory 32 and volatile memory 34. In a shared memory architecture, non-volatile memory 32 includes a launcher memory block 36, a shared memory block 38, and an application memory block 40 as described in U.S. Published Applications 2011/0307669 and 2011/0307667. The launcher memory block 36 stores code associated with a launcher. The term “code” as used herein includes binary code (i.e., binaries) or any representation of a sequence of computer instructions that can be executed by a CPU. The launcher may be configured to facilitate start-up and/or initialization of the controller, such as but not limited to loading drivers 44 and/or otherwise facilitating operations needed in order for the application to execute its desired operations. In a refinement, the launcher is operable to call shared functions, to call launcher proprietary functions, and to call application callback functions. Launcher memory block 42 has bootloader code encoded therein (i.e., stored therein). Typically, the bootloader is the first piece, or one of the first pieces, of software executed when slave controllers 26, 26′ are started or rebooted. In general, master controller 24 includes CPU 46 and memory 48. In a refinement, memory 48 includes volatile and non-volatile memory as described for slave controller 26. In some variations, updating of slave control 26's applications, including the launcher occurs via master controller 24 as slave controller 26, is not directly accessible from system bus 18. Therefore, embodiments of the invention provide a method for updating the shared memory architecture of slave controller 25, and in particular, the bootloader of slave controller 26. Shared memory block 38 has code encoded therein that is shared by applications executing on slave controller 26 including the launcher.

The application memory block 40 stores code associated with an application that is operational to perform various functions associated with the subsystem controller 12. The CPU 28 may be configured to execute operations according to instructions read from the memory 30, e.g., to facilitate operations associated with the launcher and the application. The CPU 28 may also be configured to facilitate writing code to the memory 30, such as to support some of the operations described below in more detail. The CPU 28 is shown to optionally interact with the drivers 32 used to interact with hardware components being monitored or controlled by controller 12, including hardware components required to support communications with optional controllers 14, 16 over the system bus 18. For example, subsystem controller 12 can be a component of a battery monitoring system (BMS) that includes the master controller. In this application, the slave controller has applications for measuring current flow and voltages for a vehicle battery (e.g., high voltage (HV) batteries.)

It should be appreciated that it is often necessary to periodically update non-volatile memory 32 of a memory 30 having shared memory block 38. Moreover, controllers 12, 14, 16 may be required to operate and/or communicate with other controllers 12, 14, 16 over communication bus 18 and/or wirelessly. Typically, the subsystem controllers such as controller 12 are operable to perform a number of system related tasks. U.S. patent application Ser. No. 12/486,847, entitled Battery Monitoring System, the disclosure of which is hereby incorporated in its entirety by reference, describes one such BMS.

As set forth above, controller 12 may include a volatile memory block 40 which can have a random accessory memory (RAM) block 40. The volatile memory 28, unlike the non-volatile memory 34, erases any stored code each time the controller 26 is reset or power is lost. The volatile memory 28, as described below, may be loaded with software code particular to supporting functions associated with the launcher and the application as set forth in U.S. Published Applications 2011/0307669 and 2011/0307667

The communications carried out between the controller 12 and one or more of the other controllers 14, 16 may be directed and/or executed according to communication code stored in the shared memory block 38. The communication code may be stored in the shared memory block 38 and used by both of the launcher and applications when executing communication related operations (optionally, the shared memory 38 may be used by other applications and/or features operating on the slave controller). The use of the shared memory 38 may be beneficial if the volume of communication code needed to support communications is rather larger. The ability to share the communication code, as opposed to storing separate sets of communication code for each of the launcher and application, may reduce the overall volume of communication code needed to support the launcher, application and other communication depending elements as set forth in U.S. Published Applications 2011/0307669 and 2011/0307667

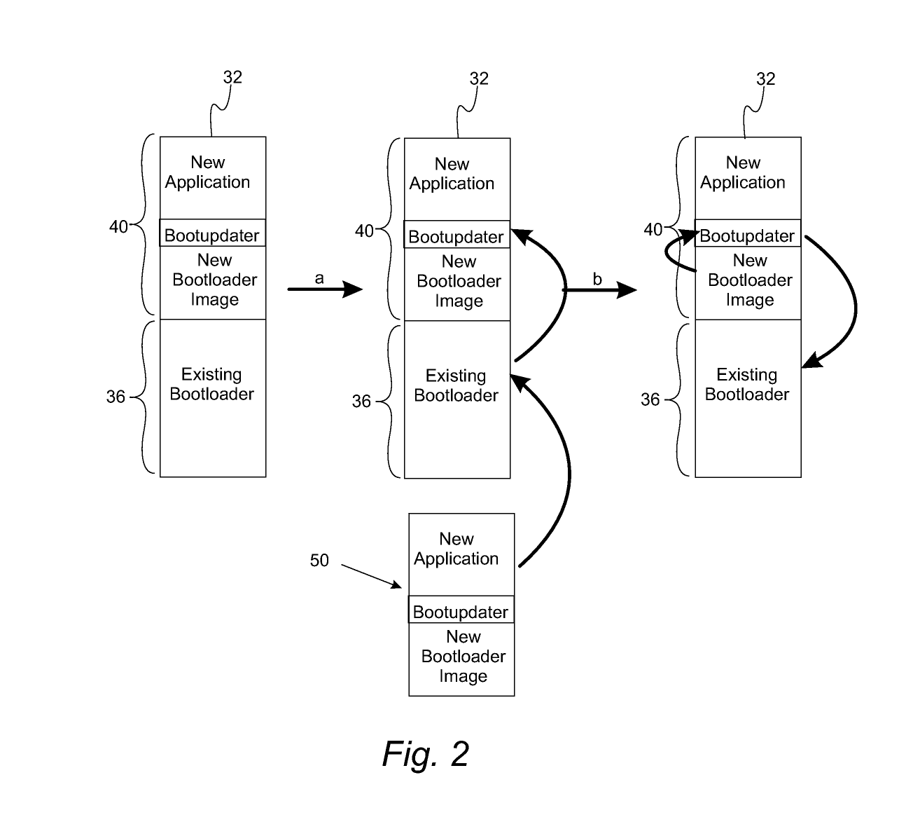

With reference to FIGS. 1 and 2, a method for updating a bootloader in a control system using a shared memory architecture is provided. FIG. 2 is a schematic flowchart illustrating the method for updating the bootloader in a slave controller 26. In step a), updated code 50 is written to an application memory block 40 of the non-volatile memory 30. The updated code 50 includes a first code section having application code for application functions, a second code section having updated bootupdater code, and a third code section having image code for an updated bootloader. In step b), slave controller 16 receives an indication to update the bootloader code 54 stored in non-volatile launcher memory block 34 and then executes the bootupdater stored in application memory block 40 to update the bootloader stored in launcher memory block 34 from the image code for an updated bootloader. In a variation, this updating occurs through master controller 20 particularly in configuration where slave controller 26 is inaccessible from system bus 18. The indication to update the bootloader code can occur at startup when having the image for updated bootloader code stored in the application memory block is newer than the bootloader code stored in the launcher memory block.

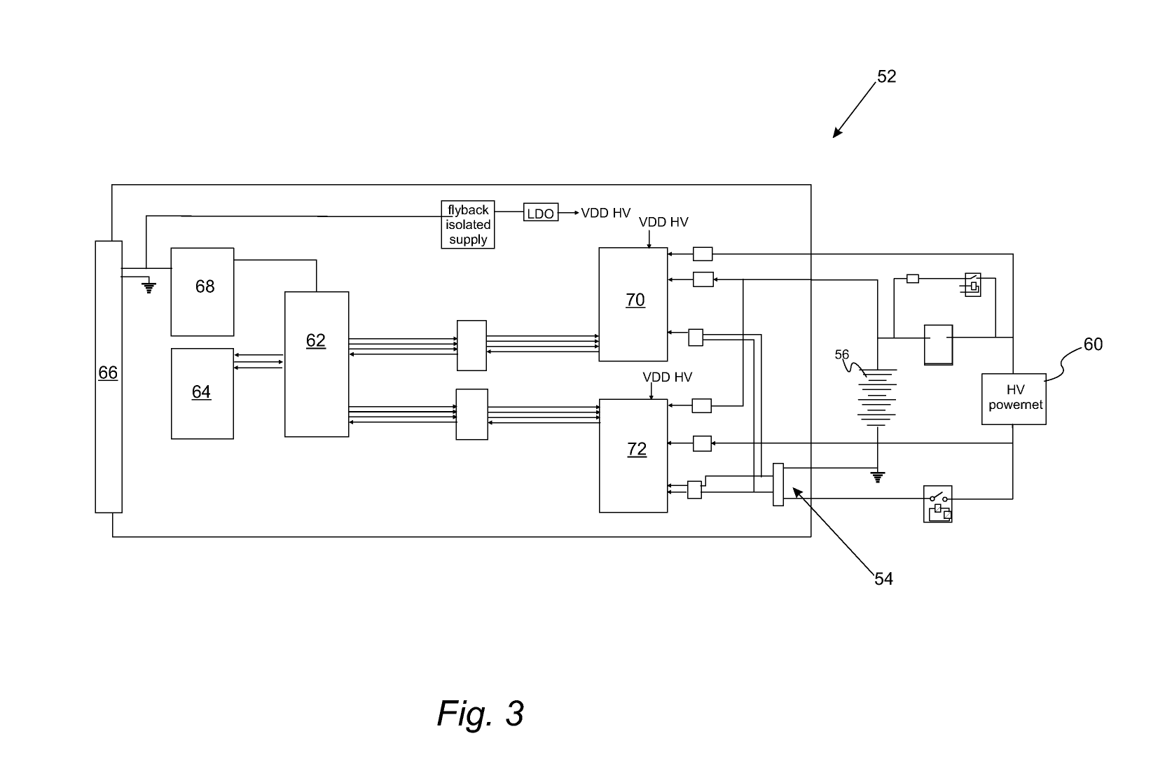

With reference to FIG. 3, a schematic illustration of a controller system having a shared memory architecture suitable for battery management system application is provided. In this example, high voltage junction box 52 measures the HV battery current through a shunt 54. Junction box 52 also measures voltages in the HV battery 56 and in the terminals of the HV DC-link which are the positive and negative sides of HV power net 60. Due to HV, the module requires isolation of measuring circuitry. Junction box 52 has one main microcontroller 62 for communication with the vehicle through vehicle bus communication transceiver 64 in communication with vehicle interface 66. Microcontroller 62 is powered by power supply 68. Microcontroller 62 controls slave microcontrollers 70 and 72 for measuring and processing the mentioned variables. Two microcontrollers are used for safety reasons (redundancy). Since microcontrollers 70 and 72 are slaves of the microcontroller 62, they are hidden to the rest of the vehicle (or in other words, do not have a network identifier) and cannot be programmed directly (either physically or through vehicle communication bus). The bootupdater described above allows reprogramming of the slave microcontrollers 70 and 72 through the main microcontroller 62.

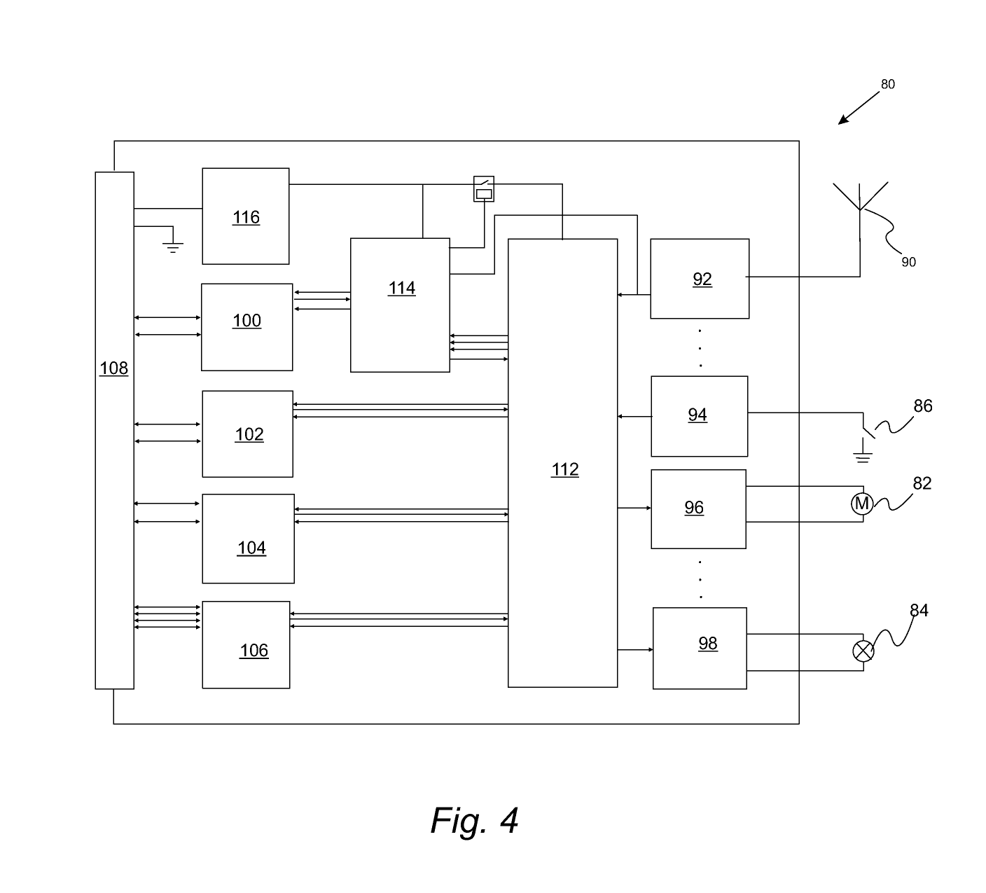

With reference to FIG. 4, a schematic illustration of a controller system having a shared memory architecture suitable for a body central module is provided. Body central module 80 is a module that controls loads 82, 84 (e.g., lights, wipers, motors, etc.), reads various switches 86 in an automobile, and monitors antenna 90 for car access. Inputs 92, 94 and outputs 96, 98 are used for these functions. Body central module 80 also functions as a main gateway in the vehicle for communication buses using vehicle bus communications transceivers 100-106 in communication with vehicle interface 108. Body central module 80 includes a main microcontroller 112 to carry out these functionalities. In some implementations, in order to reduce power consumption when the car is parked, body central module 80 includes a smaller microcontroller 114 having less power consumption and functionality than the main microcontroller 112. When the vehicle is parked, the small microcontroller 114 switches off the main microcontroller 112 and monitors the antenna or bus activity. When activity in the antenna 90 or in the vehicle bus is detected, the small microcontroller switch on the power supply 116 of main microcontroller 112 then takes over vehicle control. Typically, microcontroller 114 is a slave of the main microcontroller 112. Therefore, microcontroller 114 is hidden to the rest of the vehicle (or in other words, do not have a network identifier) and cannot be programmed directly using a programming tool. Therefore, the bootupdater described above allows reprogramming of the slave microcontrollers 114 through the main microcontroller 112.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of updating a bootloader in a slave controller, the slave controller including a central processing unit in communication with non-volatile memory having a shared memory architecture, the shared memory architecture including a non-volatile application memory block having application code and a non-volatile launcher memory block having bootloader code for initiating the slave controller:
storing updated code to an application memory block of the non-volatile memory, the updated code including a first code section including application code for application functions, a second code section including updated bootupdater code, and a third code section having image code for an updated bootloader;
receiving an indication to update the bootloader code stored in the non-volatile launcher memory block; and
executing the bootupdater stored in the application memory block to update the bootloader stored in launcher memory block from the image code for an updated bootloader.

2. The method of claim 1 further comprising storing shared code for at least one shared function to a shared memory block of the non-volatile memory.

3. The method of claim 1 wherein the indication to update the bootloader code occurs at startup when having the image for updated bootloader code stored in the application memory block is newer than the bootloader code stored in the launcher memory block.

4. The method of claim 1 wherein the indication to update the bootloader code occurs when the slave controller receives a command to update the bootloader stored in launcher memory block.

5. The method of claim 4 wherein the slave controller is in communication with a master controller.

6. The method of claim 4 wherein the launcher memory block also includes code operable to call shared functions, to call launcher proprietary functions, and to call application callback functions.

7. The method of claim 5 wherein the slave controller is a component of a battery management system (BMS) that includes the master controller, the slave controller having applications for measuring current flow and voltages for a vehicle battery, including HV batteries.

8. The method of claim 5 wherein the slave controller is a body control module is a module that controls a load selected from the group consisting of lights, wipers, motors, receivers, transmitters and combinations thereof.

9. The method of claim 5 wherein the slave controller and the master controller are each independent microcontrollers that include a microprocessor.

10. The method of claim 5 wherein at least one additional slave controller is in communication with the master controller.

11. A control system having a shared memory architecture, the control system comprising:
a master controller having a first central processing unit and a first memory;
a slave controller having a second central processing unit and a second memory, the slave controller in communication with the master controller, the second memory including non-volatile memory having:
a launcher memory block having bootloader code encoded therein;
a shared memory block having shared code encoded thereon; and
an application memory block having a first code section having application code for application functions, a second code section having updated bootupdater code, and a third code section having image code for an updated bootloader, the second central processing unit configured to receive an indication to update the bootloader code stored in the launcher memory block and execute the bootupdater code stored in the application memory block to update to bootloader stored in the launcher memory block from the image code for an updated bootloader.

12. The control system of claim 11 wherein the indication to update the bootloader code occurs at startup when having the image for updated bootloader code stored in the application memory block is newer than the bootloader code stored in the launcher memory block.

13. The control system of claim 11 wherein the indication to update the bootloader code occurs when the slave controller receives a command to update the bootloader stored in launcher memory block.

14. The control system of claim 11 wherein the launcher memory block also includes code operable to call shared functions, to call launcher proprietary functions, and to call application callback functions.

15. The control system of claim 11 wherein the slave controller is a component of a battery management system (BMS) that includes the master controller, the slave controller having applications for measuring current flow and voltages for a vehicle battery, including a high voltage battery.

16. The control system of claim 11 wherein the slave controller is a body control module is a module that controls a load selected from the group consisting of lights, wipers, motors, receivers, transmitters and combinations thereof.

17. The control system of claim 11 wherein the slave controller and the master controller are each independent microcontrollers that include a microprocessor.

18. The control system of claim 11 further comprising at least one additional slave controller in communication with the master controller.
